(19) United States
(12) Patent Application Publication
(10) Pub. No.: US 2025/0079342 A1
(43) Pub. Date: Mar. 6, 2025

(54) SECURED CRYPTO PROCESSOR FOR CHIPLET SECURITY USING ARTIFICIAL INTELLIGENCE

(71) Applicant: Applied Materials, Inc., Santa Clara, CA (US)

(72) Inventors: Shailesh Mishra, Bangalore (IN); Meghna Maheshkumar Patel, Navsari (IN)

(73) Assignee: Applied Materials, Inc., Santa Clara, CA (US)

(21) Appl. No.: 18/239,676

(22) Filed: Aug. 29, 2023

(51) Int. Cl. H01L 23/00; G06F 21/60; G06F 21/72; G06F 21/73; H01L 25/065

(52) U.S. Cl. CPC H01L 23/576; G06F 21/602; G06F 21/72; G06F 21/73; H01L 25/0655; H10B 80/00

(57) ABSTRACT

A chiplet-based system may include a first chiplet mounted to an interposer that is designated as being from one or more trusted sources, a second chiplet mounted to the interposer that is designated as not being from the one or more trusted sources, and an artificial intelligence (AI) accelerator. The AI accelerator may be programmed to monitor a state of the first chiplet, where the state may indicate an anomaly associated with the second chiplet. The AI accelerator may then select an action from a plurality of actions based at least in part on the state of the first chiplet, cause the action to be performed by the chiplet-based system, and execute a reinforcement learning algorithm update the plurality of actions based on a result of the action being performed.

### TECHNICAL FIELD

This disclosure generally describes techniques and architectures for using trusted and untrusted chiplets in a secure system. More specifically, this disclosure describes an artificial-intelligence accelerator and a cryptographic processor for identifying anomalies in untrusted chiplets.

### BACKGROUND

Chiplets are individual semiconductor chips the perform specific functions. Multiple chiplets may be assembled or interconnected together to create more complex integrated circuits unlike traditional monolithic integrated circuits (ICs) made up of a single chip implementing all of the necessary components for a function, chiplets enable a more modular approach to system design. For example, chiplets may be function-specific such as processors, memory controllers, graphic processing units, hardware accelerators, I/O devices, and so forth. Each chiplet focusing on a specific function may be individually optimized for performance, efficiency, or speed. These function-specific chiplets may be combined and interconnected on a package or substrate to create a more powerful system-on-chip (SoC). The flexibility and modularity of these chiplet-based designs not only improve and simplify the design process, but chiplets also improve manufacturing yields by producing smaller dies rather than large monolithic chips.

As chiplet designs continue to grow, package scaling concerns may begin to arise. Package scaling refers to the process of reducing the size of the physical package that houses the chiplets and other integrated circuits. Smaller packages improve signal integrity, offer smaller form factors, and are better able to manage thermal resistance between the chiplets and the surrounding environment.

### SUMMARY

In some embodiments, a chiplet-based system may include a first chiplet mounted to an interposer. The first chiplet may be designated as being from one or more trusted sources. The system may also include a second chiplet mounted to the interposer. The second chiplet may be designated as not being from the one or more trusted sources. The system may also include an artificial intelligence (AI) accelerator that is programmed to perform operations including monitoring a state of the first chiplet designated as being from the one or more trusted sources. The state of the first chiplet may indicate an anomaly associated with the second chiplet designated as not being from the one or more trusted sources. The operations may also include selecting an action from a plurality of actions based at least in part on the state of the first chiplet; causing the action to be performed by the chiplet-based system; and executing a reinforcement learning algorithm update the plurality of actions based on a result of the action being performed.

In some embodiments, a method of identifying anomalies in untrusted chiplets in chiplet-based systems may include monitoring a state of a first chiplet in a chiplet-based system. The first chiplet may be designated as being from one or more trusted sources. The state may indicate an anomaly associated with a second chiplet in the chiplet-based system. The second chiplet may be designated as not being from the one or more trusted sources. The method may also include selecting an action from a plurality of actions based at least in part on the state of the first chiplet. The action may affect the operation of a second chiplet in the chiplet-based system, and the second chiplet may be designated as not being from the one or more trusted sources. The method may also include causing the action to be performed by the chiplet-based system; and executing a reinforcement learning algorithm update the plurality of actions based on a result of the action being performed.

In some embodiments, one or more non-transitory computer-readable media may store instructions that, when executed by one or more processors, cause the one or more processors to perform operations including monitoring a state of a first chiplet in a chiplet-based system. The first chiplet may be designated as being from one or more trusted sources. The state may indicate an anomaly associated with a second chiplet in the chiplet-based system. The second chiplet may be designated as not being from the one or more trusted sources. The method may also include selecting an action from a plurality of actions based at least in part on the state of the first chiplet. The action may affect the operation of a second chiplet in the chiplet-based system, and the second chiplet may be designated as not being from the one or more trusted sources. The method may also include causing the action to be performed by the chiplet-based system; and executing a reinforcement learning algorithm update the plurality of actions based on a result of the action being performed.

In any embodiments, any and all of the following features may be implemented in any combination and without limitation. The system may also include a cryptographic processor as part of the chiplet-based system, where the cryptographic processor may also be mounted to the interposer. The cryptographic processor may be implemented as a chiplet that is separate and distinct from the first chiplet, the second chiplet, and the artificial intelligence accelerator. Causing the action to be performed may include adjusting a number of encryption cycles that are executed by the cryptographic processor to encrypt data that is transmitted between the first chiplet and the second chiplet. Causing the action to be performed may include adjusting a key length for an encryption key used by the cryptographic processor to encrypt data that is transmitted between the first chiplet and the second chiplet. The first chiplet may be part of a root-of-trust in the chiplet-based system, and the second chiplet may not be part of the root-of-trust in the chiplet-based system. Data transmitted between through the root-of-trust may be encrypted based on the action performed by the chiplet-based system. The first chiplet may include a central processing unit for the chiplet-based system. The second chiplet may include a memory chiplet. The system may also include an SRAM with an action table that stores the plurality of actions and weights associated with the plurality of actions used to select the action. The reinforcement learning algorithm may include a Q-learning algorithm or a deep Q-learning algorithm. The plurality of actions may be stored in a Q-matrix. The state of the first chiplet may be represented at least in part by values stored in performance counters of the first chiplet. The performance counters may include a power rise or change, a handshake signal result, a resource utilization amount, or an error count. The action may block access of the second chiplet to a memory, where the memory may be shared between the first chiplet and the second chiplet. The action may abort a memory transfer a memory, where the memory may be shared between the first chiplet and the second chiplet. The anomaly associated with the second chiplet may result from the second chiplet being a counterfeit chiplet. The anomaly associated with the second chiplet may represent malicious actions taken by the second chiplet.

### BRIEF DESCRIPTION OF THE DRAWINGS

A further understanding of the nature and advantages of various embodiments may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a chiplet-based system, according to some embodiments.

FIG. 2 illustrates a heterogeneous chiplet system, according to some embodiments.

FIG. 3 illustrates a block diagram of the system that details a configuration of the AI processing subsystem and/or the cryptography subsystem, according to some embodiments.

FIG. 4 illustrates a block diagram of an example hardware implementation of the AI/cryptography system, according to some embodiments.

FIG. 5 illustrates an example of an encryption data path that may be implemented by the cryptography block, according to some embodiments.

FIG. 6 illustrates a flowchart of a method of identifying anomalies in untrusted chiplets in chiplet-based systems, according to some embodiments.

FIG. 7 illustrates an exemplary computer system, in which various embodiments may be implemented.

### DETAILED DESCRIPTION

Described herein are embodiments for detecting counterfeit or malfunctioning chiplets in a chiplet-based system. Traditionally, chiplets in a secure system had to be sourced and tested from trusted sources. However, heterogeneous systems may be designed that use third-party chiplets from untrusted sources. In maintain a secure system with an trusted chiplets, the system may be divided into a root-of-trust that divides the trusted from the untrusted chiplets. In order to protect the system and detect malicious or unexpected behavior from the untrusted chiplets, and AI accelerator may be implemented that monitors the state of the system by accessing board signals and performance counters from trusted and/or untrusted chiplets. These monitored values may be used to determine an overall state of the system. By monitoring trusted chiplets, any anomalous behavior by the untrusted chiplets may also be detected as they interact with the trusted chiplets. The AI accelerator may use the state values to select one or more actions or policies that may be executed to change the system state. For example when the state deviates from a baseline set of values, the state may be submitted to a Q-matrix or other learning data structure to retrieve actions that are configured to compensate for the anomalous behavior of the untrusted chiplets. This may include actions that restrict access of the untrusted chiplets, increase the security of a crypto graphic processor, and so forth. The subsequent state of the system may be monitored to reward or punish the reinforcement learning algorithm.

A chiplet is a modular integrated circuit that is specifically designed to work with other similar modular chiplets to form a larger, more complex processing system. This allows functional blocks to be divided up into different chiplets in a design to provide greater flexibility and modularity during the design process. In contrast to conventional monolithic integrated circuit (IC) designs, chiplet-based designs use smaller independent dyes that are connected together. Each chiplet may be specifically designed to perform individual functions, such as processing cores, graphic processing units, math coprocessors, hardware accelerators, and so forth. Chiplet-based designs also decrease the cost of manufacturing, as a larger die may be divided into smaller chiplets to improve yield and binning. With the increased cost and slowing of Moore's law, conventional monolithic chip development is also becoming less attractive, as chiplets are less expensive and exhibit faster time-to-market production. The emergence of a relatively new chiplet-based ecosystem is beginning to enable an alternative way to design complex systems by integrating pre-tested chiplet dies into a larger package.

As traditional monolithic-based designs become increasingly more expensive to manufacture, chiplets have emerged as a successful alternative in system architectures to improve yields, reduce the cost of manufacture, and improve the modularity of designs. Generally, a chiplet is not a package type, but is rather part of a packaging architecture. Each chiplet may include a separate die manufactured from a silicon wafer. Instead of forcing all the functionality of the system (e.g., the central processing unit (CPU), the memory, the graphic processing unit (GPU), various peripherals, etc.) to be manufactured on one large monolithic die, chiplet-based systems separate these functionalities out into separate dies that can then be packaged together to perform the same functionality. By making individual dies smaller, the yield and manufacturing costs are reduced for the overall system.

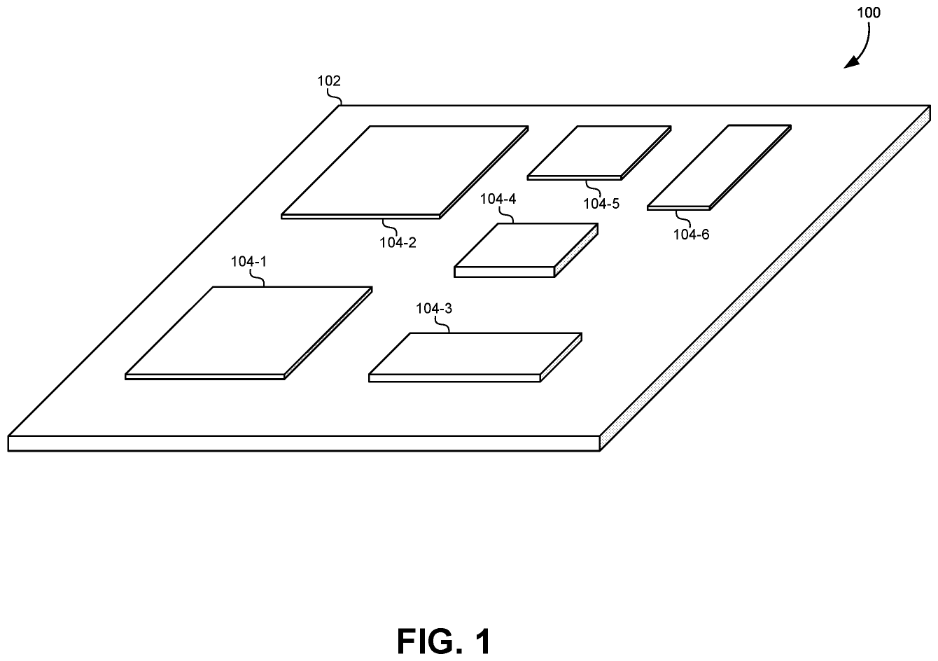

FIG. 1 illustrates a chiplet-based system 100, according to some embodiments. A plurality of chiplets 104 may be manufactured as separate dies from one or more silicon wafers. The chiplets 104 may include a plurality of different functions, such as application-specific systems-on-a-chip (SOCs), a graphics processing unit (GPU), a digital signal processor (DSP), an artificial intelligence (AI) accelerator, various codecs, Wi-Fi communication modules, memory controllers, memory caches, input/output (I/O) peripherals, and so forth. Although manufactured on separate dies, each of these chiplets 104 may be connected together using various options to perform substantially the same functions as would be performed by a similar monolithic design, but in a distributed manner.

For secure architectures, each of the chiplets 104 may be verified to have a trusted design that is physically manufactured by a trusted source. In other words, secure architectures may require that the functionality of a chiplet be tested and verified to perform in an expected, secure manner. Additionally, the physical manufacture and testing of the chiplet may be performed by a trusted source (e.g., an in-house fabrication facility, a trusted supplier, and so forth). Therefore, the most secure architectures are often designed using a homogeneous set of chiplets 104 to alleviate security concerns. As used herein, the term “homogenous” may refer to chiplets or other components that are sourced from a predefined set of trusted sources.

However, as the popularity of the chiplet-based system 100 continues to grow, there is an increasing demand for the integration of heterogeneous components fabricated on different technology nodes. For example, the flexibility of a chiplet-based system 100 may be improved by integrating chiplets 104 from a plurality of different sources. This may include chiplets manufactured from commercial sources, different countries, and/or different manufacturers. As used herein, the term “heterogeneous” may refer to a design incorporates chiplets or other components that are sourced outside of the predefined set of trusted sources. While heterogeneous designs may improve the flexibility and functionality of the system, moving beyond trusted sources for chiplets introduces a risk in the supply chain. Specifically, security and privacy challenges may be introduced by third-party, on trusted chiplets.

For example, when using chiplets from various suppliers, it is possible for a counterfeit part to be integrated into the chiplet-based system 100. This may be done with malicious intent in order to substitute a chip with similar functionality that includes malicious software, such as malware, Trojan horses, and so forth. Hackers may gain access to a backend of the supply chain and thereby shipped chiplets that are “hacked” with malicious software. The entity with the weakest security may become the weakest link in a supply chain system, exposing the chiplet-based system 102 vulnerabilities that are outside of the system designer's control in this scenario. In other cases, a counterfeit part may simply not perform the desired function as efficiently or predictably as an authentic part. This may occur when a copy of authentic chiplet—possibly using the same part numbers and die markings—is substituted for an authentic chiplet.

The embodiments described herein solve these and other technical problems, including the technical problem of identifying chiplets in a chiplet-based system 100 that do not perform as expected. Specifically, special security components such as a cryptography accelerator and an AI accelerator may work together to monitor the performance of the chiplet-based system 100 and detect chiplets that may pose a security threat. This allows for the use and integration of heterogeneous designs that sourced components from sources other than trusted sources. Instead of identifying counterfeit or malicious components during procurement, this technical solution is able to identify these types of components based on their actual performance in the system.

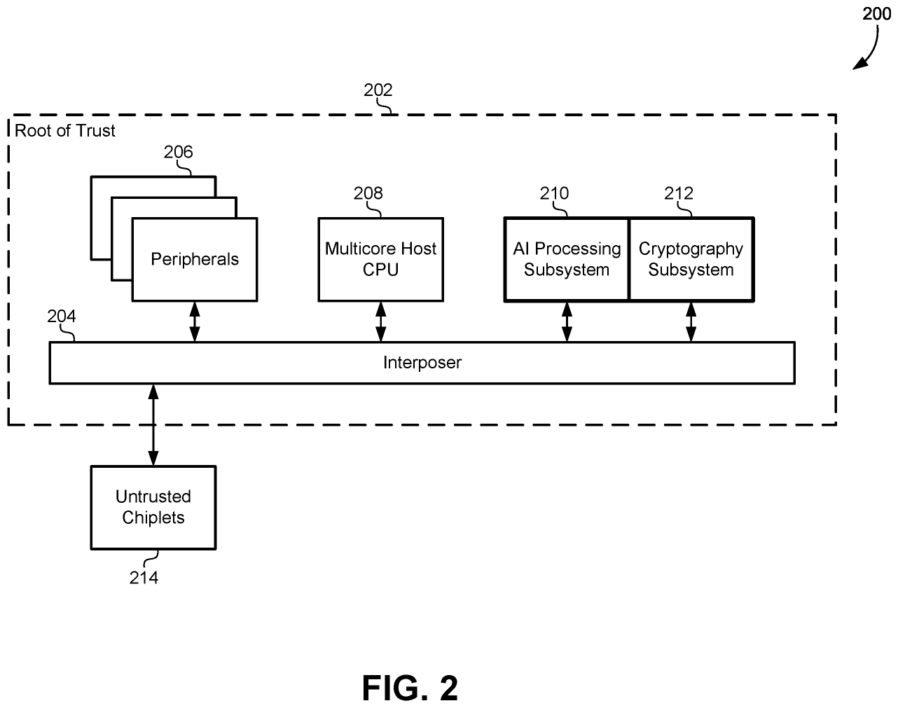

FIG. 2 illustrates a heterogeneous chiplet system 200, according to some embodiments. The system 200 may include components that are within a “root-of-trust” 202. The root-of-trust 202 may indicate components, chiplets, and/or systems that are designed, manufactured, and/or tested in trusted facilities. A trusted facility may include any facility where a specified level of security is enforced to ensure that the supplied ICs are authentic and function as intended. Any components outside of the root-of-trust 202 may be received from sources that are not designated as trusted facilities. These may include third-party suppliers, commercial vendors, and/or any other type of supplier.

The root-of-trust 202 may include a processor 208. The processor 208 may include a single processor or microcontroller. The processor 208 may also include a multicore host central processing unit. In addition to the main processor 208, the root-of-trust 202 may include other peripherals 206. The peripherals 206 may include other chiplets, such as graphics processing units, hardware accelerators, cache memories, I/O interfaces, and/or any other type of chiplet.

The peripherals 206 and the processor 208 may be communicatively coupled through an interposer 204. The interposer 204 may include an interconnect architecture that manages communication between all of the various chiplets or subsystems in the system 200. The interposer may include a substrate fabricated from materials such as silicon, glass, organic materials, resins, or other similar materials. For example, the interposer 204 may include interconnect metal layers that form a network of electrical pathways between the various chiplets in the system.

As illustrated in FIG. 2, some subsystems may reside outside of the root-of-trust 202. For example, various untrusted chiplets 214 may be integrated into the system 200. The untrusted chiplets 214 may include chiplets from various sources not designated as a trusted facility. Therefore, the system 200 may be referred to as a heterogeneous system that includes components from trusted and on trusted sources. The root-of-trust 202 illustrated in FIG. 2 may represent a logical subdivision of components in the system 200. However, the root-of-trust 202 need not represent an actual physical segregation components in the system 200, although some designs may physically separate components inside the root-of-trust 202 from other components in the system, such as dividing these components into different locations on the interposer 204. Additionally, the system may include an external memory 221 that is partitioned or logically divided into a number of different sections as described below.

In order to monitor the trusted chiplets 214, the root-of-trust 202 may be modified to include a number of new subsystems illustrated in FIG. 2. For example, an AI processing subsystem 210 and/or a cryptography subsystem 212 may be included in the root-of-trust 202 to monitor, identify, and react to any suspicious activity performed by the untrusted chiplets 214. In some embodiments, the untrusted chiplets 214 may include an external memory, which may include an AI memory used by the AI processing subsystem 210, as well as an encrypted memory that may be used by the cryptography subsystem. The system memory may be shared between different chiplets in the system 200.

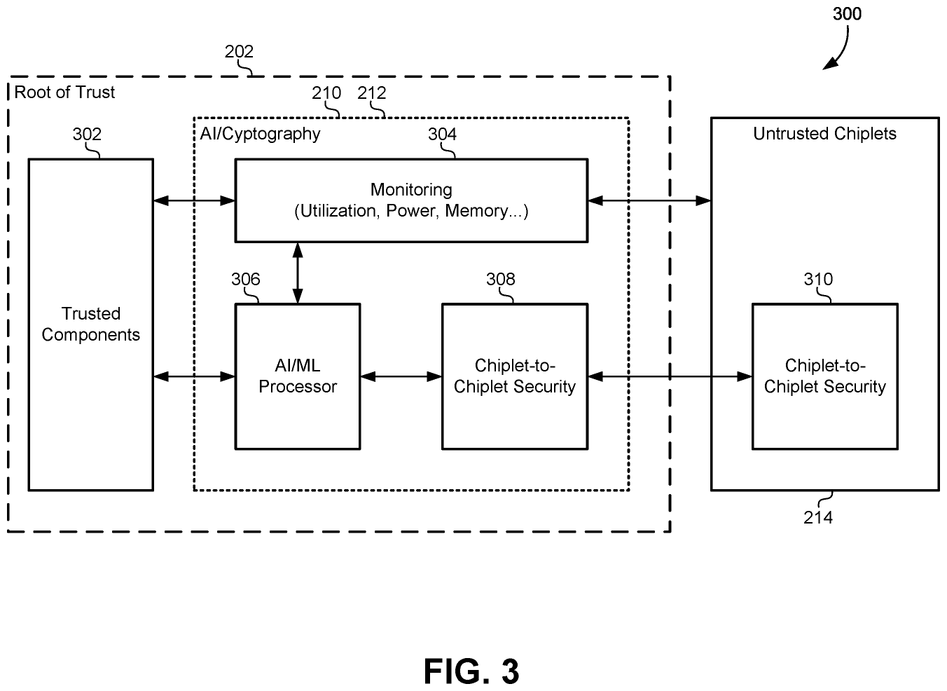

FIG. 3 illustrates a block diagram 300 of the system that details a configuration of the AI processing subsystem 210 and/or the cryptography subsystem 212, according to some embodiments. In this example, the AI processing subsystem 210 and/or the cryptography subsystem 212 are logically represented together, as these two systems may work in tandem to monitor and communicate with the rest of the system. As illustrated, these two systems may reside within the root-of-trust 202 along with other trusted components 302 described above. Encrypted communication may be maintained between the trusted systems and the untrusted chiplets 214 to facilitate runtime monitoring.

The monitoring system 304 may monitor any of the operating characteristics of any component in the system 200. For example, the monitoring system 304 may be configured to monitor the utilization of a component, the power usage of a component, the memory usage of a component, a bandwidth of a component, specific operations performed by a component, and/or any other electrical or operational characteristics of a component. The monitoring system 304 may retrieve and/or store information from each of the other components in the system 200. This information may then be analyzed to determine whether the component or other related components are functioning as expected. In some embodiments, the monitored information may also be used as an environment for a reinforcement learning algorithm described below.

In some embodiments, the monitoring system 304 may monitor signals in the system. For example, the monitoring system 304 may monitor bus transactions in the interposer, signal outputs from various components, readings from sensors or other specific monitoring devices, and so forth. Additionally, the monitoring system 304 may query and/or retrieve information from the components themselves. For example, many chiplets may be configured with counters or registers that track operations, power usage, bandwidth, and/or other operating characteristics of the chiplets. These registers may also be referred to as performance counters in some technologies. Chiplets may be configured to provide information from their performance counters in response to a request. These performance counters may also be used by hardware profilers. However, the embodiments described herein may retrieve this information for integrated security purposes. For example, values retrieved from the performance counters may reveal bandwidth usage of a communication device, cache transactions and/or cache usage or misses, specific operations performed by the chiplets, real-time power usage, and so forth. Any of these values may be retrieved, stored, and/or analyzed by the monitoring system 304. The monitoring system 304 may also include custom counters or registers that store information regarding chiplet performance. These custom counters may be added in addition to the counters corresponding to the performance counters from the chiplets themselves.

In some embodiments, the monitoring system 304 may focus specifically on the performance and operation of the processor 208, along with any other chiplets that operate in conjunction with the operation of the processor 208 (e.g., processor caches, GPUs, and so forth). The operation of the processor 208 may be affected by the operation of other chiplets in the system, including the untrusted chiplets 214. Therefore, some embodiments may characterize the baseline or normal operation of the system 200 by monitoring all of the operational parameters of the processor 208. This may be used to indicate a normal operation of the system and may be used for comparison to abnormal situations to identify a chiplet from the untrusted chiplets 214 that may be performing in an unexpected manner. Additionally, the monitoring system 304 may monitor any of the untrusted chiplets 214 or other trusted chiplets within the root of trust 202.

In some embodiments, the AI/ML processor 306 may analyze the real time information retrieved by the monitoring system 304. The AI/ML processor 306 may be configured to identify deviations from the normal operation of the processor 208 and/or other systems using, for example, a reinforcement learning algorithm as described below. For example, the AI/ML processor 306 may identify abnormally high utilization of the processor 208, an abnormally high rate of cache misses, and abnormally high temperature reading from a temperature sensor, and/or any other abnormal condition. When such a condition is detected by the AI/ML processor 306, the AI/ML processor 306 me initiate a corrective action to remediate the abnormal condition, depending on the severity of the condition. For example, the AI/ML processor 306 may communicate with a security block 308 to change security parameters such, as increasing a key size for encrypting data passing into or out of the root-of-trust 202. More generally, the more severe the abnormal condition detected by the AI/ML processor 306, the more the security level of the security block 300 any may be increased.

This architecture allows the AI/cryptography system to monitor the behavior of trusted components 302 in order to detect an anomalous condition caused by the malfunction or malicious activity of one or more of the untrusted chiplets 214. Since the trusted components 302 reside within the root-of-trust 202, any anomalous condition may be blamed on chiplets or components outside of the root-of-trust 202.

In some embodiments, the AI/ML processor 306 may use a reinforcement learning algorithm that is subjected to rewards and/or penalties for corrective actions. For example, if an anomalous condition is detected by the AI/ML processor 306, and the AI/ML processor 306 ma initiate a corrective action, and the monitoring system 304 may continue to monitor parameters after the corrective action is taken. If the parameters that caused the anomalous condition to be detected in the first place return to a normal level after the corrective action is taken, then the reinforcement learning algorithm may reward that corrective action in a learning table such that the corrective action is more likely to be taken in the future in a similar situation. Conversely, if the parameters that cause the anomalous condition to be detected do not return to a normal level (or become worse), the reinforcement learning algorithm may punish the corrective action such that the action is less likely to be taken in the future in a similar situation.

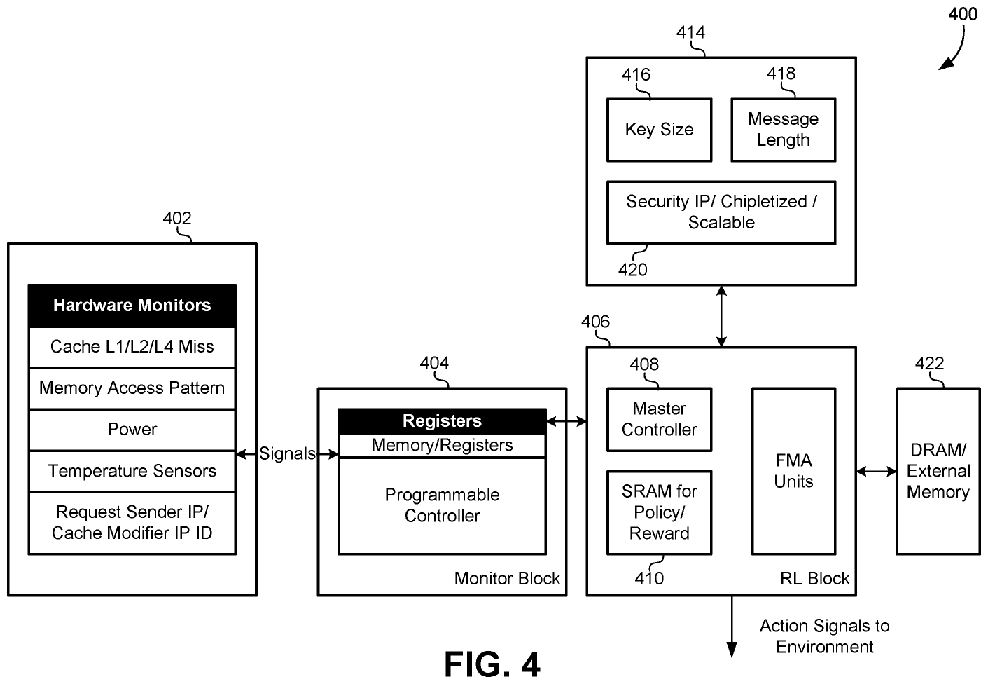

FIG. 4 illustrates a block diagram 400 of an example hardware implementation of the AI/cryptography system, according to some embodiments. As described above, the components 402 may include hardware monitor registers, performance counters, and/or other internal stored values that monitor the performance of the components 402. The AI/cryptography system may include corresponding registers in a monitor block 404 that retrieve and store values from the performance counters in the components 402. The components 402 that are monitored may include trusted components as well as untrusted components in the system. Additionally or alternatively, the monitor block 404 may retrieve and store values from signals that are monitored on the circuit board, such as sensors, and/or other components in the system. Additional custom registers may also be included in the monitor block 404 that include additional information, such as an operation or instruction being executed when an anomaly was detected.

A custom AI accelerator 406 may be used to perform many of the operations by the system. For example, the AI accelerator 406 may implement a reinforcement learning algorithm (e.g., Q learning or deep Q-learning) in order to analyze the current state of the system as indicated in the registers of the monitor block 404 and take an appropriate action as defined by a Q matrix or other action table. For example, a master controller 408 may act as an agent. The controller 408 may retrieve one or more of the register stored in the monitor block 408 in order to define a current “state” of the system. In the context of a traditional learning algorithm, the surrounding “environment” may be ascertained by the inputs from the monitor block 404 to define the state of the environment.

Different implementations may utilize various machine-learning algorithms. For example, some embodiments may utilize a reinforcement learning algorithm, such as Q learning. Generally, reinforcement learning (RL) algorithms represent a class of machine-learning algorithms that make sequential decisions within an environment in order to maximize a reward signal. The RL algorithms interact with an environment, receive feedback in the form of the reward or punishment inputs, and refine the action selection mechanism in order to maximize rewards in the future. A Q-learning model represents a model-free RL algorithm that utilizes a Q-function. The Q-function represents an action-value function typically stored in a table that stores the expected rewards for possible state-action pairs. For example, a current state may be provided to the table, and the table may select a corresponding action. Some embodiments may extend the Q-learning algorithm using a deep Q-network that incorporates a neural network. Other embodiments may use different reinforcement learning algorithms, such as policy gradient methods, actor-critic methods, Monte Carlo methods, proximal policy optimization methods, and other similar techniques.

The master controller 408 may provide the state to a Q-matrix or other learning action table in order to retrieve an action. The action table may be stored in an SRAM or other memory 410. For example, the master controller 408 may select an action having the highest predicted reward in the table. Some embodiments may also include a random or pseudorandom element as part of the selection process to occasionally choose different actions. The action may be based on a policy or security policy that specifies a number of different conditions or actions that may be taken based on the environment. For example, a security policy may be selected from the action or Q-table, and the selected policy may cause changes to the cryptographic parameters of a cryptography block 414. In some embodiments, the cryptography block 414 may be chipletized itself and implemented as a distinct chip or chiplet in the system. The security policy may also specify the key size 416 for different system conditions. The security policy may also specify a message length 418 and/or other parameters 420, such as a cryptographic algorithm used and types of messages that should be encrypted. In short, the selected policy may specify a plurality of different actions that may affect different chiplets in the system.

The master controller 408 may select a policy based on the state provided from the monitor block 404. Master controller 408 may then output one or more actions to be taken based on the policy. For example, one or more the values from the monitor block 404 may indicate that a key size 416 should be increased. The master controller 408 may then output an action to increase the key size 416. Each policy may generate a number of different actions based on the current state.

The learning portion of the RL algorithm may then continue to monitor the same values that generated the action. As subsequent values populate the registers in the monitor block 404, the master controller 408 may ascertain whether the previous actions taken from the policy have caused the monitor values to return to a normal baseline value. A reward signal may be generated if the action returned the values back to a normal range or in the direction of the normal range. In reinforcement learning, an objective may be to maximize the cumulative reward for an action over time. A numerical reward may be generated from the environment (e.g., the monitor block 404) indicating the effectiveness of a particular action. The numerical value for the reward may be proportional to its effectiveness in changing the state of the system back to a normal baseline level of performance. Some embodiments may also include a discount factor (e.g., between 0.0 and 1.0) that scales the importance of future rewards relative to a current reward. The reward may be fed back into the system to adjust the values stored in the memory 410 for the action table of the RL algorithm.

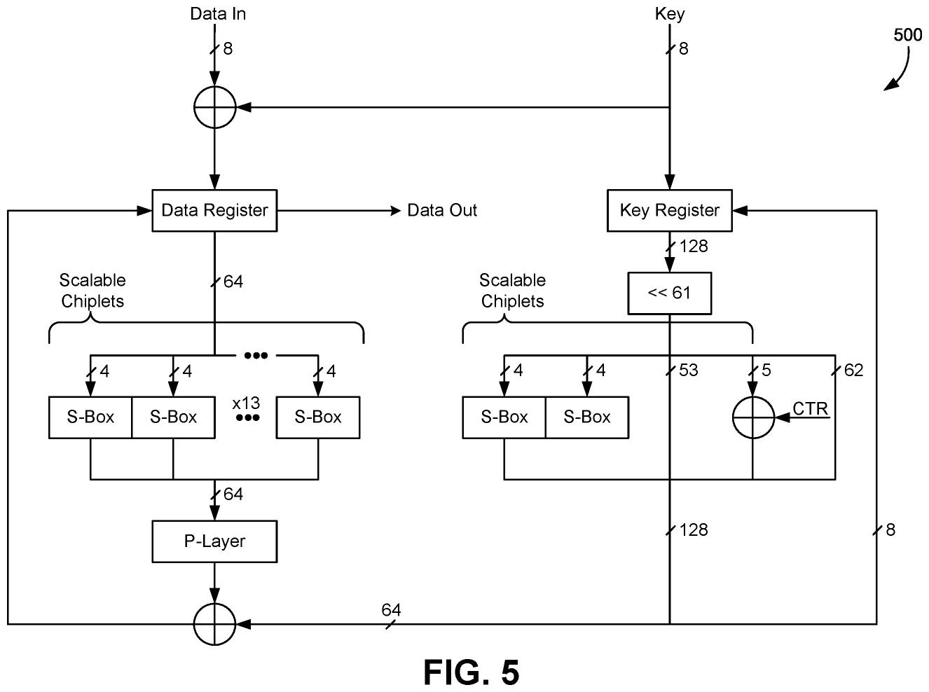

FIG. 5 illustrates an example of an encryption data path that may be implemented by the cryptography block 414, according to some embodiments. Note that the data path widths illustrated in FIG. 5 are provided only by way of example and are not meant to be limiting. This example implements a symmetric key algorithm or block cipher, and the algorithm may be based on a substitution-permutation network (SPN). As depicted in FIG. 5, the algorithm accepts a data input and performs substitutions in the substitution boxes (S-Boxes), then passes the output to a permutation layer (P-Layer). The key may be scrambled and combined with the data to encrypt the data. Note that each of the S-Boxes may be implemented as scalable chiplets.

The data path may support 64-bit data inputs and/or 80-128 bits for the symmetric encryption key. In this example, an 8-bit input and output bus may be used for the data bit, the key bits, and the cipher inputs. A variable number of encryption rounds may be used (e.g., 32 rounds of encryption). However, the key length, number of data bits, and number of encryption rounds may all be adjustable at runtime in response to actions taken by the learning algorithm. Some actions may also change the permutation the takes place in the permutation layer as an action output. For example, in response to a state indicating a severe anomaly in the system, the number of permutation rounds may be increased to a large number (e.g., 32 rounds). However, in order to improve the performance of the system and increase throughput, a normal state may generate an action that decreases the number of permutation rounds to a much smaller number (e.g., 4 rounds, 6 rounds, 8 rounds, 10 rounds, etc.). This encryption algorithm may be used by each of the encryption blocks in the system described above. For example, any data being transferred to/from the root-of-trust to any other chiplets or systems outside of the rooted trust may be encrypted. This may include information stored in the AI memory 216, the encrypted memory, and/other storage elements. This may also include communications between untrusted chiplets 214 and any of the chiplets within the root-of-trust 202.

An example use case may illustrate how the components described above may be used to detect a particular type of attack based on performance counters and take an action in response. The AI/machine learning engine may detect unusual activity using the performance counters in the monitor block 404 as retrieved from the processor. As described above, the unusual activity, such as detecting cache incoherency, may be represented as a state that is defined by the values of the performance counters. This state may be used to select a policy or action from an action matrix that is populated and refined by a machine-learning algorithm. The policy may define a number of actions that may be executed by the master controller and/or the processor. These actions may include providing a prompt to a user, adjusting a key size or optimal security algorithm depending on the state, and so forth. It should be noted that the AI accelerator described above greatly accelerates the detection process. If the same process were performed using software executed by the processor alone, this would not only decrease the performance of the processor, but may also delay the detection time considerably. The cache incoherency may be detected, security measures may be increased (e.g., increased encryption strength), and the cache coherency may be restored.

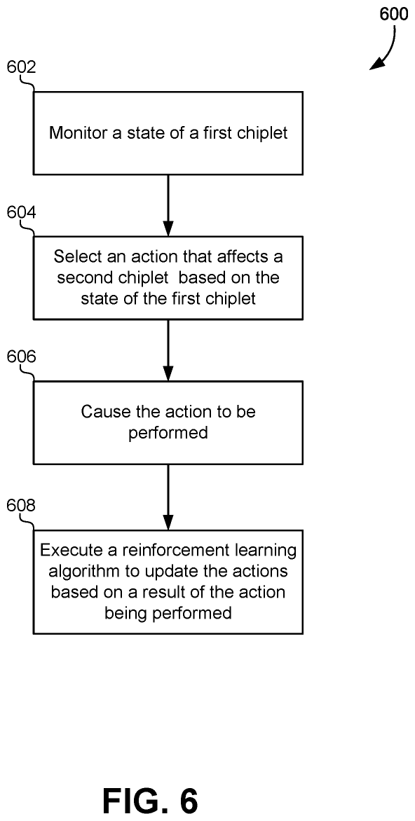

FIG. 6 illustrates a flowchart 600 of a method of identifying anomalies in untrusted chiplets in chiplet-based systems, according to some embodiments. The method may include monitoring a state of a first chiplet in a chiplet-based system (602). For example, the state of the first chiplet may be monitored by a monitoring system 304 as depicted in FIG. 3. The state of the first chiplet may be monitored by receiving or polling values from a performance counter on the first chiplet. The performance counters may store any information relevant to the operation of the first chiplet, such as a resource utilization amount, power usage, and error counts, handshake signal results, power rise/fall times, communication protocol statuses, and so forth. Additionally, the AI/cryptography system may monitor signals from sensors, signal traces, and/or other inputs in the chiplet-based system.

The first chiplet may designated as being from one or more trusted sources. Conversely, the second chiplet may be designated as not being from the one or more trusted sources. In some embodiments, the chiplets in the system may be divided logically such that the first chiplet is within a root-of-trust, while the second chiplet is outside of the root-of-trust. For example, the root-of-trust may describe systems that are trusted within the chiplet-based system such that data does not need to be encrypted within the root-of-trust, but is encrypted when passing outside of the root-of-trust. By way of example, the first chiplet may include a central processing unit for the chiplet-based system as depicted in FIG. 2. The second chiplet may include any peripheral, such as an auxiliary processor, a memory chiplet, a hardware accelerator, and so forth. Each of the chiplets be mounted on an interposer. The interposer may be a single substrate or may be divided into multiple substrates in a 3D stack that are communicatively coupled through connectors, vias, or other conductive pathways.

The state may comprise a state for a reinforcement learning algorithm. The state may be inferred or represented by the values monitored in the system. For example, the state of the system may indicate that one of the untrusted chiplets is performing the in an anomalous fashion (e.g., not performing within specifications or performing unexpected operations). This anomaly may be associated with the second chiplet even though the state of the first chiplet is being monitored. As described above, the first chiplet (e.g., a processor) may record information relevant to the entire system or relevant to communications between the first chiplet and the second chiplet in order to reveal the anomaly associated with the second chiplet. The anomaly may result from the second chiplet being a counterfeit or inauthentic part. The anomaly may also represent malicious actions taken by the second chiplet when the second chiplet has been replaced by a hacker or other malicious actor.

The method may additionally include selecting an action from a plurality of actions based at least in part on the state of the first chiplet (604). As described above, the plurality of actions may represent possible actions that may be executed by the AI accelerator. The actions may be stored in a data structure such as a table, matrix, database, and so forth. When a reinforcement learning algorithm is used, the actions may be stored with weights that indicates which actions should be taken to correspond with each state. For example, a Q-matrix may accept a state as an input and return an action that will most likely generate an optimal result associated with that state.

Generally, the action selected may affect the operation of the second chiplet in the chiplet-based system. For example, the action may include adjusting the operation of a cryptographic processor. The cryptographic processor may also be mounted to the interposer structure of the system and may be a separate and distinct chiplet in relation to the first chiplet, the second chiplet, and/or the AI accelerator. Actions may adjust the operation of the cryptographic processor by adjusting a key length, adjusting a number of encryption cycles performed on each data segment, switching between cryptographic algorithms, cycling keys, and so forth. Other actions may adjust power provided to the second chiplet, may cancel or restart transactions with the second chiplet, may block access by the second chiplet to other chiplets in the system, and so forth. For example, where the second chiplet accesses a memory that is shared between one or more chiplets in the system, the action may block access of the second chiplet to the memory or abort a memory transfer to/from the memory.

The method may also include causing the action to be performed by the chiplet-based system (606). For example, the AI accelerator may send a command to the first chiplet (e.g., a core CPU) to change various aspects of the system operation. In some embodiments, the action taken may cause the first chiplet to send another command to the second chiplet or to other chiplets to alter their operations. The AI accelerator may also send a command directly to the second chiplet.

The method may further include executing a reinforcement learning algorithm to update the plurality of actions based on a result of the action being performed (608). As described above, the system may continue to monitor the state of the first chiplet and/or other chiplets or signals in the chiplet-based system. If an action was taken in response to an abnormal state, it may be determined whether the action taken generated the desirable result, i.e., caused the state to return to a normal or baseline state. If the action caused the state return to normal (or within a threshold distance of a set of baseline values), the AI accelerator may generate a reward that is applied to the actions, for example, stored in the Q-matrix. A positive reward may adjust weights applied to each action making it more likely that the selected action will be chosen in the future for that state. Conversely, a negative reward may adjust these weights to make the selected action less likely to be chosen.)

It should be appreciated that the specific steps illustrated in FIG. 6 provide particular methods of identifying anomalies in chiplet-based systems according to various embodiments. Other sequences of steps may also be performed according to alternative embodiments. For example, alternative embodiments may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. Many variations, modifications, and alternatives also fall within the scope of this disclosure.

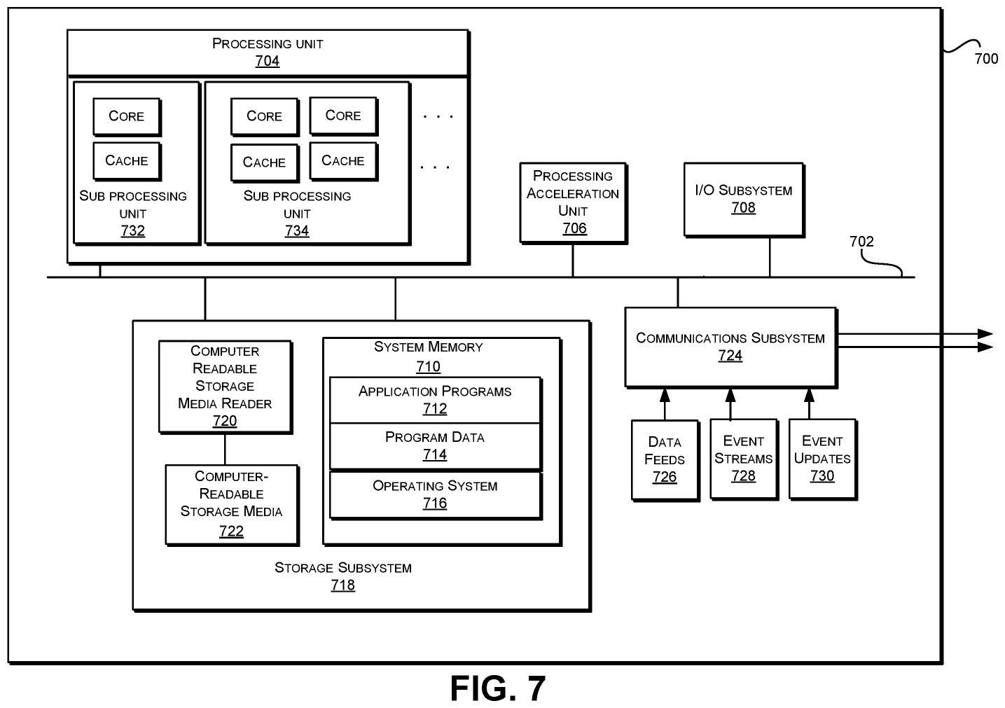

FIG. 7 illustrates an exemplary computer system 700, in which various embodiments may be implemented. The system 700 may be used to implement any of the computer systems described above. For example, the system 700 may be implemented on a chiplet in the chiplet-based system 200. Alternatively, individual components of the system 700 may be implemented on individual chiplets in the chiplet-based system 200. For example, the processing unit 704, the communication subsystem 724, the I/O subsystem 708, the processing acceleration unit 706, and/or other systems may each be implemented individually as chiplets in the chiplet-based system 200. As shown in the figure, computer system 700 includes a processing unit 704 that communicates with a number of peripheral subsystems via a bus subsystem 702. These peripheral subsystems may include a processing acceleration unit 706, an I/O subsystem 708, a storage subsystem 718 and a communications subsystem 724. Storage subsystem 718 includes tangible computer-readable storage media 722 and a system memory 710.

Bus subsystem 702 provides a mechanism for letting the various components and subsystems of computer system 700 communicate with each other as intended. Although bus subsystem 702 is shown schematically as a single bus, alternative embodiments of the bus subsystem may utilize multiple buses. Bus subsystem 702 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 704, which can be implemented as one or more integrated circuits (e.g., a conventional microprocessor or microcontroller), controls the operation of computer system 700. One or more processors may be included in processing unit 704. These processors may include single core or multicore processors. In certain embodiments, processing unit 704 may be implemented as one or more independent processing units 732 and/or 734 with single or multicore processors included in each processing unit. In other embodiments, processing unit 704 may also be implemented as a quad-core processing unit formed by integrating two dual-core processors into a single chip.

In various embodiments, processing unit 704 can execute a variety of programs in response to program code and can maintain multiple concurrently executing programs or processes. At any given time, some or all of the program code to be executed can be resident in processor(s) 704 and/or in storage subsystem 718. Through suitable programming, processor(s) 704 can provide various functionalities described above. Computer system 700 may additionally include a processing acceleration unit 706, which can include a digital signal processor (DSP), a special-purpose processor, and/or the like.

I/O subsystem 708 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 700 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 700 may comprise a storage subsystem 718 that comprises software elements, shown as being currently located within a system memory 710. System memory 710 may store program instructions that are loadable and executable on processing unit 704, as well as data generated during the execution of these programs.

Depending on the configuration and type of computer system 700, system memory 710 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 704. In some implementations, system memory 710 may include multiple different types of memory, such as static random access memory (SRAM) or dynamic random access memory (DRAM). In some implementations, a basic input/output system (BIOS), containing the basic routines that help to transfer information between elements within computer system 700, such as during start-up, may typically be stored in the ROM. By way of example, and not limitation, system memory 710 also illustrates application programs 712, which may include client applications, Web browsers, mid-tier applications, relational database management systems (RDBMS), etc., program data 714, and an operating system 716. By way of example, operating system 716 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 718 may also provide a tangible computer-readable storage medium for storing the basic programming and data constructs that provide the functionality of some embodiments. Software (programs, code modules, instructions) that when executed by a processor provide the functionality described above may be stored in storage subsystem 718. These software modules or instructions may be executed by processing unit 704. Storage subsystem 718 may also provide a repository for storing data used in accordance with some embodiments.

Storage subsystem 700 may also include a computer-readable storage media reader 720 that can further be connected to computer-readable storage media 722. Together and, optionally, in combination with system memory 710, computer-readable storage media 722 may comprehensively represent remote, local, fixed, and/or removable storage devices plus storage media for temporarily and/or more permanently containing, storing, transmitting, and retrieving computer-readable information.

Computer-readable storage media 722 containing code, or portions of code, can also include any appropriate media, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 700.

By way of example, computer-readable storage media 722 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 722 may include, but is not limited to, Zip® drives, flash memory cards, universal serial bus (USB) flash drives, secure digital (SD) cards, DVD disks, digital video tape, and the like. Computer-readable storage media 722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 700.

Communications subsystem 724 provides an interface to other computer systems and networks. Communications subsystem 724 serves as an interface for receiving data from and transmitting data to other systems from computer system 700. For example, communications subsystem 724 may enable computer system 700 to connect to one or more devices via the Internet. In some embodiments communications subsystem 724 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 724 can provide wired network connectivity (e.g., Ethernet) in addition to or instead of a wireless interface.

In some embodiments, communications subsystem 724 may also receive input communication in the form of structured and/or unstructured data feeds 726, event streams 728, event updates 730, and the like on behalf of one or more users who may use computer system 700.

By way of example, communications subsystem 724 may be configured to receive data feeds 726 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 724 may also be configured to receive data in the form of continuous data streams, which may include event streams 728 of real-time events and/or event updates 730, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 724 may also be configured to output the structured and/or unstructured data feeds 726, event streams 728, event updates 730, and the like to one or more databases that may be in communication with one or more streaming data source computers coupled to computer system 700.

Computer system 700 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 700 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, other ways and/or methods to implement the various embodiments should be apparent.

As used herein, the terms “about” or “approximately” or “substantially” may be interpreted as being within a range that would be expected by one having ordinary skill in the art in light of the specification.

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have been described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, features are described with reference to specific embodiments thereof, but it should be recognized that not all embodiments are limited thereto. Various features and aspects of some embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A chiplet-based system comprising:
a first chiplet mounted to an interposer, wherein the first chiplet is designated as being from one or more trusted sources;
a second chiplet mounted to the interposer, wherein the second chiplet is designated as not being from the one or more trusted sources;
an artificial intelligence accelerator that is programmed to perform operations comprising:
monitoring a state of the first chiplet designated as being from the one or more trusted sources, wherein the state of the first chiplet indicates an anomaly associated with the second chiplet designated as not being from the one or more trusted sources;
selecting an action from a plurality of actions based at least in part on the state of the first chiplet;
causing the action to be performed by the chiplet-based system; and
executing a reinforcement learning algorithm to update the plurality of actions based on a result of the action being performed.

2. The chiplet-based system of claim 1, further comprising a cryptographic processor as part of the chiplet-based system, wherein the cryptographic processor is also mounted to the interposer.

3. The chiplet-based system of claim 2, wherein the cryptographic processor is implemented as a chiplet that is separate and distinct from the first chiplet, the second chiplet, and the artificial intelligence accelerator.

4. The chiplet-based system of claim 2, wherein causing the action to be performed comprises adjusting a number of encryption cycles that are executed by the cryptographic processor to encrypt data that is transmitted between the first chiplet and the second chiplet.

5. The chiplet-based system of claim 2, wherein causing the action to be performed comprises adjusting a key length for an encryption key used by the cryptographic processor to encrypt data that is transmitted between the first chiplet and the second chiplet.

6. The chiplet-based system of claim 1, wherein the first chiplet is part of a root-of-trust in the chiplet-based system, and the second chiplet is not part of the root-of-trust in the chiplet-based system.

7. The chiplet-based system of claim 6, wherein data transmitted between through the root-of-trust is encrypted based on the action performed by the chiplet-based system.

8. The chiplet-based system of claim 1, wherein the first chiplet comprises a central processing unit for the chiplet-based system.

9. The chiplet-based system of claim 1, wherein the second chiplet comprises a memory chiplet.

10. The chiplet-based system of claim 1, further comprising an SRAM with an action table that stores the plurality of actions and weights associated with the plurality of actions used to select the action.

11. A method of identifying anomalies in untrusted chiplets in chiplet-based systems, the method comprising:
monitoring a state of a first chiplet in a chiplet-based system, wherein the first chiplet is designated as being from one or more trusted sources, the state indicates an anomaly associated with a second chiplet in the chiplet-based system, and the second chiplet is designated as not being from the one or more trusted sources;
selecting an action from a plurality of actions based at least in part on the state of the first chiplet, wherein the action affects the operation of a second chiplet in the chiplet-based system, and the second chiplet is designated as not being from the one or more trusted sources;
causing the action to be performed by the chiplet-based system; and
executing a reinforcement learning algorithm to update the plurality of actions based on a result of the action being performed.

12. The method of claim 11, wherein the reinforcement learning algorithm comprises a Q-learning algorithm or a deep Q-learning algorithm.

13. The method of claim 12, wherein the plurality of actions are stored in a Q-matrix.

14. The method of claim 11, wherein the state of the first chiplet is represented at least in part by values stored in performance counters of the first chiplet.

15. The method of claim 14, wherein the performance counters comprise a power rise, a handshake signal result, a resource utilization amount, a cache status, a processor core status, a memory status, or an error count.

16. The method of claim 11, wherein the action blocks access of the second chiplet to a memory, wherein the memory is shared between the first chiplet and the second chiplet.

17. The method of claim 11, wherein the action aborts a memory transfer a memory, wherein the memory is shared between the first chiplet and the second chiplet.

18. One or more non-transitory computer-readable media comprising instructions that, when executed by one or more processors, cause the one or more processors to perform operations comprising:
monitoring a state of a first chiplet in a chiplet-based system, wherein the first chiplet is designated as being from the one or more trusted sources, the state indicates an anomaly associated with a second chiplet in the chiplet-based system, and the second chiplet is designated as not being from the one or more trusted sources
selecting an action from a plurality of actions based at least in part on the state of the first chiplet, wherein the action affects the operation of a second chiplet in the chiplet-based system, and the second chiplet is designated as not being from the one or more trusted sources;
causing the action to be performed by the chiplet-based system; and
executing a reinforcement learning algorithm to update the plurality of actions based on a result of the action being performed.

19. The one or more non-transitory computer-readable media of claim 18, wherein the anomaly associated with the second chiplet results from the second chiplet being a counterfeit chiplet.

20. The one or more non-transitory computer-readable media of claim 18, wherein the anomaly associated with the second chiplet represents malicious actions taken by the second chiplet.
